(19) United States
(12) Patent Application Publication
(10) Pub. No.: US 2023/0227000 A1
(43) Pub. Date: Jul. 20, 2023

(54) POSITION DETERMINATION SYSTEM

(71) Applicant: KABUSHIKI KAISHA TOKAI RIKA DENKI SEISAKUSHO, Aichi (JP)

(72) Inventors: Yoshiki KATO, Aichi (JP); Masanori KOSUGI, Aichi (JP); Tadashi FUKAGAI, Aichi (JP); Nobuaki TSUTSUMI, Aichi (JP)

(73) Assignee: KABUSHIKI KAISHA TOKAI RIKA DENKI SEISAKUSHO, Aichi (JP)

(21) Appl. No.: 17/928,679

(22) PCT Filed: Jun. 21, 2021
(86) PCT No.: PCT/JP2021/023314

§ 371 Date: Nov. 30, 2022

(30) Foreign Application Priority Data
Jun. 23, 2020 (JP) 2020-107999

(51) Int. Cl. B60R 25/24; G07C 9/00

(52) U.S. Cl. CPC B60R 25/24; G07C 9/00309; B60R 2325/10; G07C 2209/63; G08C 2201/91

(57) ABSTRACT

Provided in a vehicle are: an external communications unit provided outside the compartment of the vehicle; and an internal communications unit provided inside the vehicle compartment. A position determination system includes a data acquisition unit that obtains reception signal strength data for radio waves that have been communicated and measured, between the external communications unit and a terminal and between the internal communications unit and the terminal. The position determination system also includes a position determination unit that determines whether the terminal is positioned outside or inside the vehicle, from the results of comparison between the size of data obtained from communication between the external communications unit and the terminal and between the internal communications unit and the terminal. In addition, the external communications unit is disposed inside a body component located around a rear wheel of the vehicle.

### TECHNICAL FIELD

The present invention relates to a position determination system that determines the position of a terminal relative to a vehicle when the terminal establishes communication with the vehicle.

### BACKGROUND ART

A known example of a vehicle communication system controls a vehicle through wireless communication established between a terminal, which is carried by a user, and a vehicle on-board device, which is installed in the vehicle. A smart verification system is a known communication system in which a terminal automatically responds to radio waves transmitted from a vehicle on-board device and performs ID authentication through wireless communication.

Patent Literature 1 discloses a smart verification system that includes a position determination system for determining the position of a terminal relative to a vehicle. When an on-board device and a terminal establish communication, the position determination system measures a received signal strength of the radio waves received by the terminal from a communication unit mounted on the vehicle to determine a position that corresponds to the received signal strength as the position of the terminal. The smart verification system uses the position determination system to determine whether the terminal is located near the vehicle.

### CITATION LIST

### Patent Literature

Patent Literature 1: US Patent Application Publication No. 2015/0235486

### SUMMARY OF INVENTION

### Technical Problem

The communication unit is accommodated in the inner side of the vehicle and not exposed to the outside. Thus, metal body parts forming the external structure of the vehicle may attenuate the radio waves transmitted from the communication unit and reduce the received signal strength of the radio waves received by the terminal that is located outside the vehicle. In this case, the position of the terminal cannot be determined correctly.

An objective of the present invention is to provide a position determination system that allows the position of the terminal to be determined correctly.

### Solution to Problem

A position determination system according to one aspect of the present invention includes a data acquisition unit and a position determination unit. The data acquisition unit obtains received signal strength data of a received signal strength measured from radio waves used in communication performed between a terminal and an exterior communication unit, outside a passenger compartment of a vehicle, and received signal strength data of a received signal strength measured from radio waves used in communication performed between the terminal and an interior communication unit, arranged inside the passenger compartment of the vehicle. The position determination unit that determines whether the terminal is located outside or inside the passenger compartment of the vehicle from a comparison result of the received signal strength data obtained through communication performed between the terminal and the exterior communication unit and the received signal strength data obtained through communication performed between the terminal and the interior communication unit. The exterior communication unit is arranged inside a body part near a rear wheel of the vehicle.

### Advantageous Effects of Invention

The position determination system according to the present invention allows the position of the terminal to be determined correctly.

### BRIEF DESCRIPTION OF DRAWINGS

FIG. 1 is a block diagram showing the configuration of a position determination system arranged in an authentication system in accordance with an embodiment.

FIG. 2 is a perspective view showing the external appearance of a vehicle.

FIG. 3 is a plan view showing the arrangement of an exterior communication unit and an interior communication unit.

FIG. 4 is a side view showing the arrangement of the exterior communication unit and the interior communication unit.

FIG. 5 is a flowchart illustrating the flow of authentication performed by the vehicle and a portable terminal.

FIG. 6 is a plan view showing propagation paths of radio waves when the terminal is located outside the vehicle.

FIG. 7 is a plan view showing propagation paths of radio waves when the terminal is located inside the vehicle.

FIG. 8 is a diagram illustrating determination of a vehicle-rear area.

FIG. 9 is a cross-sectional view showing the arrangement of an exterior communication unit in accordance with another embodiment.

### DESCRIPTION OF EMBODIMENT

An embodiment of a position determination system will now be described with reference to the drawings.

As shown in FIG. 1, a vehicle 1 includes an authentication system 3 that authenticates the validity of a terminal 2 through wireless communication. Preferably, the terminal 2 is a high-performance mobile phone, or a smartphone, that includes the functionality of a phone and is capable of performing communication with the vehicle 1 through near-range wireless communication. The authentication system 3 of the present example is a near-range wireless communication verification system that performs ID verification through near-range wireless communication when communication is established with the vehicle 1. Preferably, the near-range wireless communication is Bluetooth® communication.

The vehicle 1 includes a verification electronic control unit (ECU) 4, a body ECU 5, and an engine ECU 7. The verification ECU 4 executes ID verification. The body ECU 5 manages the power supply of vehicle on-board electric components. The engine ECU 7 controls an engine 6. The ECUs are connected to one another by a communication line 8 in the vehicle. The communication line 8 is, for example, a Controller Area Network (CAN) or a Local Interconnect Network (LIN).

The verification ECU 4 includes a memory 9. An electronic key ID and a key-unique code of the terminal 2 registered to the vehicle 1 are written to and stored in the memory 9. In the authentication system 3, the verification ECU 4 and the terminal 2 communicate with each other to automatically perform a series of ID verification processes. The accomplishment of ID verification is one condition for permitting the locking and unlocking of a door lock and the starting of the engine.

The body ECU 5 controls actuation of a door lock device 11, which serves as a mechanical part for locking and unlocking a vehicle door 10. The vehicle door 10 includes an exterior door handle 12 for opening and closing the vehicle door 10. A touch sensor 13 is arranged on the exterior door handle 12 to detect when the user touches the exterior door handle 12 to, for example, unlock the door. Further, a lock button 14 is arranged on the exterior door handle 12 and operated, for example, to lock the door. When ID verification is accomplished and the terminal 2 is located outside a passenger compartment of the vehicle 1, the body ECU 5 controls actuation of the door lock device 11 based on a detection signal of the touch sensor 13 or the lock button 14.

The engine ECU 7 controls actuation of the engine 6 of the vehicle 1. The vehicle 1 includes an engine switch 15 for switching the power supply state of the engine 6. Preferably, the engine switch 15 is, for example, a push-type switch. When the engine switch 15 is operated under a predetermined condition, the engine ECU 7 controls switching of the state of the engine 6. Examples of the predetermined condition include ID verification having been accomplished, the terminal 2 being located inside the passenger compartment of the vehicle 1, the brake pedal (not shown) of the vehicle 1 being depressed, the transmission of the vehicle 1 being in the parking position, or a combination of two or more of these conditions.

The vehicle 1 includes an exterior communication unit 16 and an interior communication unit 17 for performing near-range wireless communication with the terminal 2. The exterior communication unit 16 is arranged toward the outer side of the passenger compartment of the vehicle 1. The interior communication unit 17 is arranged toward the inner side of the passenger compartment of the vehicle 1. The exterior communication unit 16 and the interior communication unit 17 perform Bluetooth Low Energy (BLE) communication with the terminal 2. Further, the exterior communication unit 16 and the interior communication unit 17 each include a unique communication unit ID. The communication unit IDs are used to identify communication units from one another.

During BLE communication of the present example, the terminal 2 serves as the master, and the vehicle 1 serves as a slave. The master-slave relationship is not limited to this configuration. The vehicle 1 may serve as the master, and the terminal 2 may serve as a slave. The exterior communication unit 16 and the interior communication unit 17 periodically transmit an advertisement message to an area proximate to the vehicle 1.

The terminal 2 includes a terminal controller 20, a network communication module 21, and a terminal communication unit 22. The terminal controller 20 controls actuation of the terminal 2. The network communication module 21 of the terminal 2 performs network communication. The terminal communication unit 22 of the terminal 2 performs BLE communication.

When the terminal 2 is used as an electronic key of the vehicle 1, the terminal 2 performs electronic key registration to register the electronic key ID and the key-unique code of the terminal 2 to the vehicle 1. For example, the terminal 2 obtains the electronic key ID and the key-unique code from a server (not shown) through network communication and writes and stores the electronic key ID and the key-unique code to a memory 24. Further, the terminal 2 connects to the vehicle 1 through BLE communication to register the electronic key ID and the key-unique code of the terminal 2. Preferably, user authentication using a user ID or the like is required for the connection of the terminal 2 and the vehicle 1.

When the terminal 2 receives an advertisement message from the vehicle 1, the terminal 2 performs a series of communication connection processes following the advertisement message. Then, when BLE communication is established between the terminal 2 and the vehicle 1, the terminal 2 automatically performs ID verification through the communication with the vehicle 1 under the condition that the electronic key registration of the terminal 2 has been completed. For example, in ID verification, the verification ECU 4 and the terminal controller 20 exchange the electronic key ID and verify the electronic key ID. Also, encrypted authentication such as challenge-response authentication is performed using the key-unique code. When the above-described verification and authentication are accomplished, the verification ECU 4 determines that the ID verification succeeded. The series of ID verification processes is automatically executed without a user operating the terminal 2 or the vehicle 1.

The authentication system 3 includes a position determination system 30 that determines the position of the terminal 2 relative to the vehicle 1 when the vehicle 1 and the terminal 2 establish communication. The position determination system 30 of the present example determines whether the terminal 2 is located inside or outside the passenger compartment of the vehicle 1 when the vehicle 1 and the terminal 2 perform ID verification. Further, the position determination may be performed whenever communication is performed for ID verification. Specifically, the position determination may be performed before, after, or during ID verification.

The position determination system 30 includes a position determination unit 31 that determines the position of the terminal 2 relative to the vehicle 1. The position determination unit 31 of the present embodiment is arranged in the verification ECU 4 of the vehicle 1. In the present embodiment, the position determination unit 31 transmits radio waves Sd that include a communication unit ID from the exterior communication unit 16 and the interior communication unit 17. The radio waves Sd are, for example, a position detection signal transmitted for position detection. In a series of position determination processes, the exterior communication unit 16 and the interior communication unit 17 each transmit the radio waves Sd a number of times. Further, the exterior communication unit 16 and the interior communication unit 17 transmit the radio waves Sd with the same power.

The position determination system 30 includes a measurement unit 32 that measures the received signal strength of the radio waves Sd received by the terminal 2 from the exterior communication unit 16 and the interior communication unit 17 for each frequency of the radio waves Sd. The measurement unit 32 of the present embodiment is arranged in the terminal controller 20 of the terminal 2. When the measurement unit 32 receives the radio waves Sd from the exterior communication unit 16 and the interior communication unit 17 via the terminal communication unit 22, the measurement unit 32 measures the received signal strength indicator (RSSI) of the radio waves Sd. The measurement unit 32 measures the received signal strength for each time the received radio waves Sd is received and transmits the measurement result to the verification ECU 4. The transmitted measurement result of the received signal strength is associated with, for example, the communication unit ID included in the radio waves Sd.

The position determination system 30 includes a data acquisition unit 33 in the verification ECU 4 to obtain received signal strength data when a measurement result is received from the measurement unit 32. The received signal strength data is, for example, the average value of the received signal strengths.

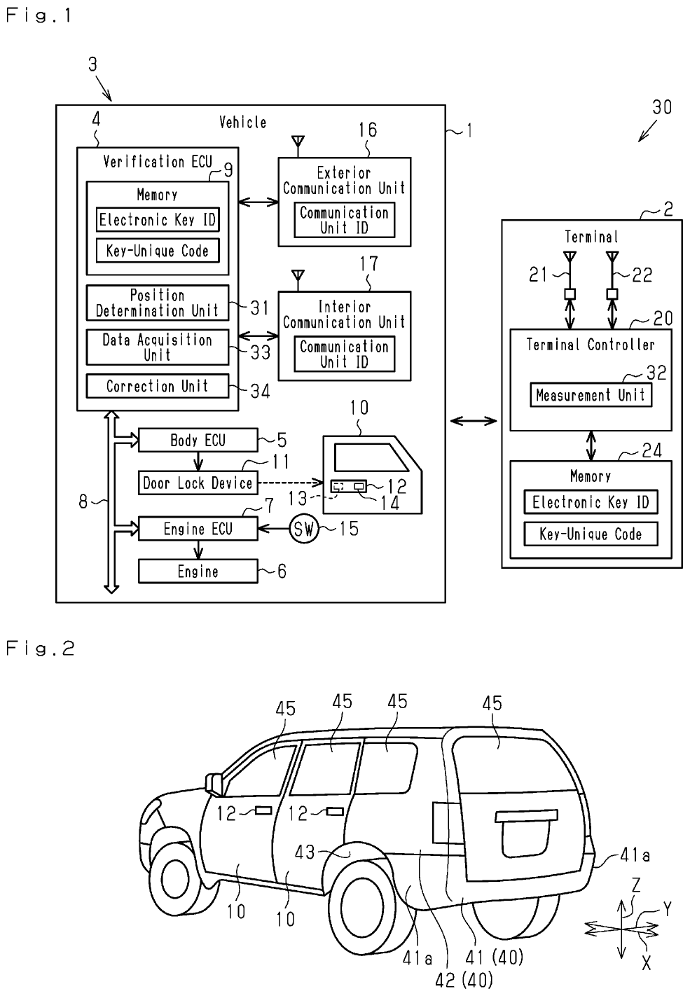

As shown in FIG. 2, a plurality of body parts 40 forms the external structure of the vehicle 1. The vehicle 1 has a vehicle longitudinal direction, a vehicle transverse direction, and a vehicle height direction. In FIG. 2, the X-axis indicates the vehicle longitudinal direction, the Y-axis indicates the vehicle transverse direction, and the Z-axis indicates the vehicle height direction. The body parts 40 include a rear bumper 41 and rear fenders 42 arranged at a rear part of the vehicle 1. The rear bumper 41 is formed from resin. The rear fenders 42 are formed from metal. The rear bumper 41 and the rear fenders 42 serve as the body parts 40 arranged near the rear wheels of the vehicle 1. The rear bumper 41 extends over the rear part of the vehicle 1 in the vehicle transverse direction. The rear bumper 41 has two ends 41a in the vehicle transverse direction that form side surfaces of the vehicle 1 in the vehicle transverse direction. Further, the ends 41a are located toward the rear from the rear wheels. The rear fenders 42 are arranged at two sides in the vehicle transverse direction. Each rear fender 42 is located upward from the corresponding rear wheel. Further, in the rear bumper 41 and the rear fender 42, a wheel well cover 43 is disposed facing the rear wheel in the vicinity of the rear wheel. The wheel well cover 43 is formed from a resin material.

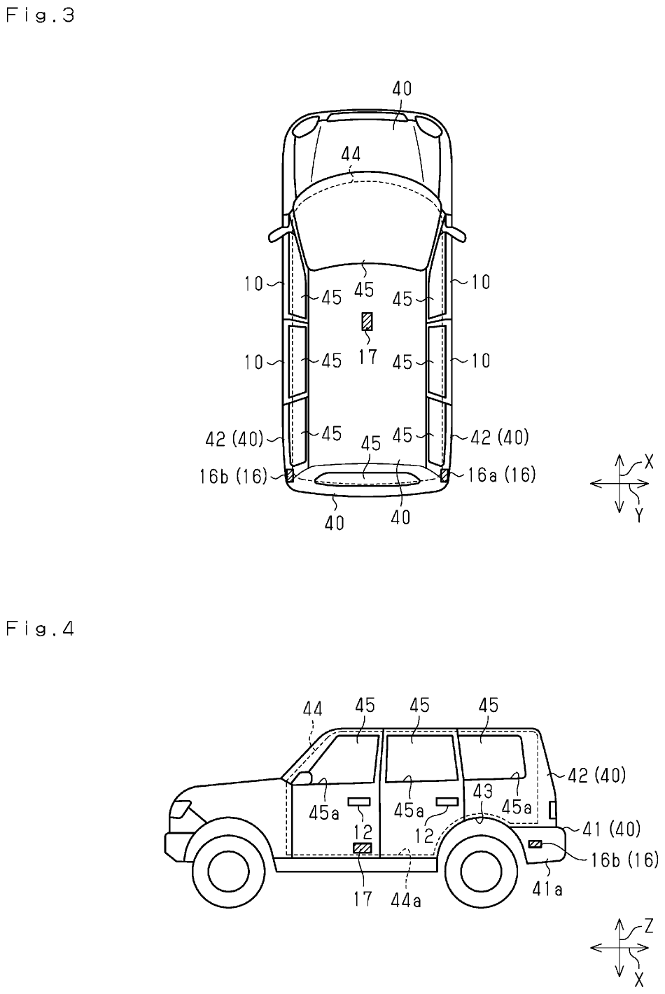

As shown in FIGS. 3 and 4, the interior communication unit 17 is arranged inside the passenger compartment of the vehicle 1, and exterior communication units 16 are arranged outside the passenger compartment of the vehicle 1. Here, the phrase “inside the passenger compartment of the vehicle” refers to, for example, the inside of a passenger compartment 44 that is surrounded by the vehicle doors 10 and the body parts 40 such as the roof. Also, the phrase “outside the passenger compartment of the vehicle” refers to the outside of the passenger compartment 44. Further, a transmissive member 45 is arranged in the external structure of the passenger compartment 44 through which radio waves Sd are transmitted. The transmissive member 45 includes glass members such as the windshield at the front of the vehicle, the side windows in the vehicle doors 10, and the rear window at the rear of the vehicle. The transmissive member 45 is arranged at a position separated from a floor surface 44a of the passenger compartment 44 in the vehicle height direction.

The interior communication unit 17 is arranged inside the passenger compartment of the vehicle proximate to the floor surface 44a. Here, the phrase “proximate to the floor surface 44a” refers to, for example, a position that is lower than an end line 45a of the lower end of the transmissive member 45. Preferably, the interior communication unit 17 is located in a central part of the passenger compartment 44 in the vehicle longitudinal direction and the vehicle transverse direction. For example, the interior communication unit 17 is arranged in the center console or below the driver seat or the passenger seat.

The exterior communication units 16 are arranged outside the passenger compartment of the vehicle 1 on the two sides of the vehicle 1 in the vehicle transverse direction. The exterior communication units 16 of the present embodiment are located at symmetric positions in the vehicle transverse direction. The exterior communication units 16 are arranged inside the rear bumper 41. Further, the exterior communication units 16 are arranged in the ends 41a of the rear bumper 41 in the vehicle transverse direction. In this manner, the exterior communication units 16 are located toward the side surfaces of the vehicle 1 in the vehicle transverse direction and covered by the rear bumper 41 at the rear of the rear wheels.

In the present embodiment, the exterior communication units 16 include a first exterior communication unit 16a arranged on a first side of the vehicle 1 in the vehicle transverse direction and a second exterior communication unit 16b arranged on a second side of the vehicle 1 in the vehicle transverse direction. Hereinafter, the first side of the vehicle 1 in the vehicle transverse direction will be described as the right side of the vehicle 1, and the second side of the vehicle 1 in the vehicle transverse direction will be described as the left side of the vehicle 1. The interior communication unit 17, the first exterior communication unit 16a, and the second exterior communication unit 16b are similar BLE communication units.

The measurement unit 32 measures a received signal strength A of the radio waves Sd transmitted from the first exterior communication unit 16a, a received signal strength B of the radio waves Sd transmitted from the second exterior communication unit 16b, and a received signal strength C of the radio waves Sd transmitted from the interior communication unit 17.

The data acquisition unit 33 calculates the average value of the received signal strengths A to form received signal strength data Da (hereafter, data Da) obtained through communication performed between the first exterior communication unit 16a and the terminal 2. The data acquisition unit 33 calculates the average value of the received signal strengths B to form received signal strength data Db (hereafter, data Db) obtained through communication performed between the second exterior communication unit 16b and the terminal 2. The data acquisition unit 33 calculates the average value of the received signal strengths C to form received signal strength data Dc (hereafter, data Dc) obtained through communication performed between the interior communication unit 17 and the terminal 2. Data Da and data Db correspond to “first received signal strength data”, and Data Dc corresponds to “second received signal strength data”.

The position determination unit 31 compares data Da, data Db, and data Dc to determine whether the terminal 2 is located inside or outside the passenger compartment of the vehicle 1. In an example, the position determination unit 31 compares values related to the received signal strengths included in data Da, data Db, and data Dc, for example, the average values of the received signal strengths, to determine whether the terminal 2 is located inside or outside the passenger compartment of the vehicle 1. The position determination unit 31 of the present embodiment determines whether the terminal 2 is located in the rightward area Ea outside the passenger compartment, the leftward area Eb outside the passenger compartment, or the internal area Ec inside the passenger compartment (refer to FIG. 6).

Further, the position determination unit 31 compares data Da and data Db to a predetermined threshold value to determine whether the terminal 2 is located in the rearward area Ed outside the passenger compartment of the vehicle 1. When determining that the terminal 2 is located in either area Ea or area Eb and data Da and data Db are both greater than or equal to the predetermined threshold value, the position determination unit 31 determines that the terminal 2 is located in area Ed.

The position determination system 30 includes a correction unit 34 that corrects at least one of data Da and Db, serving as the first received signal strength data, and data Dc, serving as the second received signal strength data. The correction unit 34 of the present embodiment performs correction using a correction amount F that is set in advance. The position determination unit 31 compares data Da, data Db, and data Dc that are corrected by the correction unit 34.

The operation of the present embodiment will now be described.

As shown in FIG. 6, in S101 (hereafter, “S” stands for step), the verification ECU 4 repetitively transmits an advertisement message sequentially from the exterior communication units 16 and the interior communication unit 17 to areas proximate to the vehicle so as to connect with the terminal 2 through BLE communication. When the terminal 2 enters an area proximate to the vehicle 1 and receives the advertisement message, the terminal 2 establishes communication with the communication unit that transmitted the advertisement message and initiates BLE communication with the vehicle 1.

In S102, when device authentication is accomplished through a series of communication connection processes following the advertisement message, the vehicle 1 and the terminal 2 are automatically connected in a manner allowing for communication. The two devices will remain connected until the terminal 2 moves out of the BLE communication range formed around the vehicle 1.

In S103, when the vehicle 1 and the terminal 2 are connected and communication is established, the vehicle 1 and the terminal 2 initiate ID verification. The ID verification includes transmission of the electronic key ID and encrypted authentication that uses the key-unique code. When either the verification of the electronic key ID or the encrypted authentication using the key-unique code is unsuccessful, the verification ECU 4 determines that ID verification is unsuccessful. When ID verification is not successful, actuation of the vehicle 1 will be prohibited. When ID verification is accomplished, the verification ECU 4 continues the process.

In S104, the position determination unit 31 transmits radio waves Sd from the exterior communication units 16 and the interior communication unit 17. The radio waves Sd include the communication unit ID of the corresponding communication unit so that the terminal 2 can identify the one of the exterior communication units 16 and the interior communication unit 17 that transmitted the radio waves Sd. Further, it is preferred that the communication units transmit the radio waves Sd at different times or on different frequencies so that the terminal 2 can receive the radio waves Sd from different communication units separately. The position determination unit 31 has the measurement unit 32 of the terminal 2 measure the received signal strengths of the radio waves Sd. When the measurement unit 32 measures the received signal strengths A, B, and C of the radio waves Sd, the measurement unit 32 notifies the verification ECU 4 of the measurement results. The data acquisition unit 33 of the verification ECU 4 stores the measurement results in the memory 9.

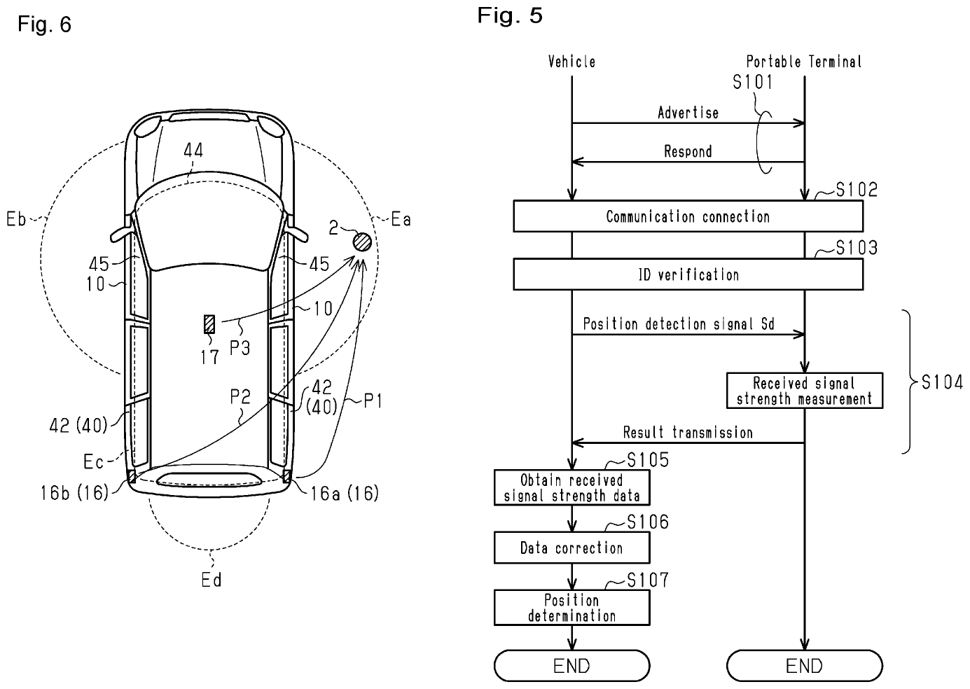

The position determination unit 31 repetitively executes a series of processes including the transmission of radio waves, the measurement of the received signal strength, and the notification of the measurement result with each of the exterior communication units 16 and the interior communication unit 17. In the present embodiment, the series of processes are repetitively executed on different frequencies through frequency hopping. FIG. 5 illustrates the series of processes executed only once. This obtains a numerical value group of the received signal strengths measured through communication with the terminal 2 for each of the first exterior communication unit 16a, the second exterior communication unit 16b, and the interior communication unit 17. Specifically, the data acquisition unit 33 obtains a numerical value group for each of the received signal strengths A of the first exterior communication unit 16a, the received signal strengths B of the second exterior communication unit 16b, and the received signal strengths C of the interior communication unit 17.

In S105, the data acquisition unit 33 obtains data Da, data Db, and data Dc based on the received signal strength A, the received signal strength B, and the received signal strength C, respectively. In the present embodiment, the data acquisition unit 33 calculates the average value for each of the received signal strengths A, B, and C from the corresponding numerical value group of the received signal strengths A, B, and C. Then, the data acquisition unit 33 obtains the average value of the received signal strengths A as data Da, the average value of the received signal strengths B as data Db, and the average value of the received signal strengths C as data Dc.

The relationship of propagation paths of radio waves Sd from the vehicle 1 to the terminal 2 and the received signal strengths will now be described.

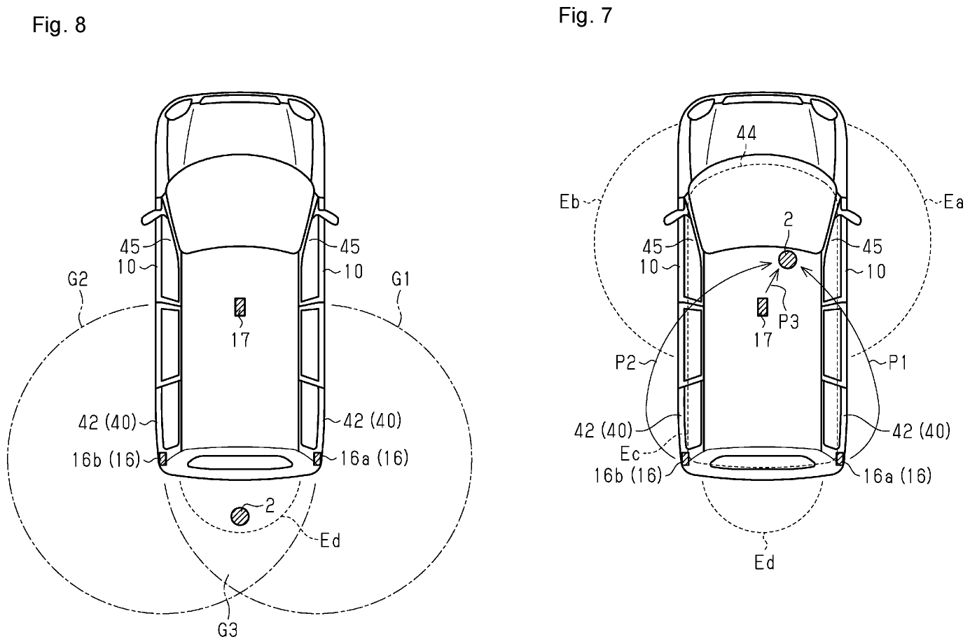

As shown in FIGS. 6 and 7, between the vehicle 1 and the terminal 2, a propagation path P1 of radio waves Sd extends from the first exterior communication unit 16a to the terminal 2, a propagation path P2 of radio waves Sd extends from the second exterior communication unit 16b to the terminal 2, and a propagation path P3 of radio waves Sd extends from the interior communication unit 17 to the terminal 2. The propagation paths P1, P2, and P3 include various types of paths through which the transmitted radio waves Sd travel to the terminal 2 as direct waves, diffracted waves, or reflected waves. When a barrier is located in the propagation paths P1, P2, and P3, the barrier blocks the radio waves Sd and reduces the received signal strengths of the radio waves Sd. That is, the barrier causes a loss in the received signal strength of the radio waves Sd.

As shown in FIG. 6, when the terminal 2 is located outside the passenger compartment of the vehicle, the radio waves Sd transmitted from the exterior communication units 16 travel through the rear bumper 41, which is formed from a resin material, to the terminal 2. When the terminal 2 is located outside the passenger compartment of the vehicle, metal barriers such as the vehicle doors 10 and the body parts 40 of the passenger compartment 44 are located in the propagation path P3 of the radio waves Sd transmitted from the interior communication unit 17. The radio waves Sd transmitted from the interior communication unit 17 are diffracted by the barriers and propagated through the transmissive member 45 out of the vehicle. This diffraction results in a loss in the received signal strength of the radio waves Sd.

When the terminal 2 is located at the right side of the vehicle 1 outside the passenger compartment, the propagation path P2 has a relatively longer propagation distance than the propagation path P1. Also, the metal body parts 40 act as barriers in the propagation path P2. When the terminal 2 is located at the left side of the vehicle 1 outside the passenger compartment, the propagation path P1 has a relatively longer propagation distance than the propagation path P2. Also, the metal body parts 40 act as barriers in the propagation path P1. Therefore, when the terminal 2 is located at the right side of the vehicle 1 outside the passenger compartment, the received signal strength A will usually be the largest of the received signal strengths A, B, and C. Further, when the terminal 2 is located at the left side of the vehicle 1 outside the passenger compartment, the received signal strength B will usually be the largest of the received signal strengths A, B, and C.

As shown in FIG. 7, when the terminal 2 is located inside the passenger compartment of the vehicle, the metal body parts 40 and the metal vehicle doors 10 forming the passenger compartment 44 act as barriers in the propagation path P1 and the propagation path P2. The radio waves Sd transmitted from the exterior communication units 16 are diffracted by the barriers and propagated through the transmissive member 45 into the vehicle. Thus, the received signal strength C will usually be the largest of the received signal strengths A, B, and C.

As described above, it can be expected that the comparison of the received signal strengths A, B, and C allows for determination of whether the terminal 2 is located in the rightward area Ea outside the passenger compartment, the leftward area Eb outside the passenger compartment, or the internal area Ec inside the passenger compartment. Also, when the average values of the received signal strengths A, B, and C are compared as data Da, Db, and Dc, the measurement results are less affected by differences in measurements of the received signal strengths A, B, and C.

As shown in FIG. 5, in S106, the correction unit 34 corrects data Da and data Db. The correction unit 34 uses the preset correction amount F to correct data Da and data Db calculated by the data acquisition unit 33. The correction amount F is set in advance based on, for example, results of experiments that are conducted with the position determination system 30 installed in the vehicle 1. For example, the correction unit 34 adds the correction amount F to data Da and data Db to facilitate determination that the terminal 2 is located outside the passenger compartment when it is. Further, the correction unit 34 subtracts the correction amount F from data Da and data Db to facilitate determination that the terminal 2 is located inside the passenger compartment when it is.

In S107, the position determination unit 31 compares the corrected data Da, Db, and Dc to determine the area of the vehicle 1 in which the terminal 2 is located. In an example, the position determination unit 31 compares values related to the received signal strengths included in the corrected data Da, Db, and Dc, for example, the average values of the received signal strengths, to determine the area of the vehicle 1 in which the terminal 2 is located. For example, when data Da is the largest of data Da, Db, and Dc, the position determination unit 31 determines that the terminal 2 is located in area Ea. When data Db is the largest of data Da, Db, and Dc, the position determination unit 31 determines that the terminal 2 is located in area Eb. When data Dc is the largest of data Da, Db, and Dc, the position determination unit 31 determines that the terminal 2 is located in area Ec.

As shown in FIG. 8, the exterior communication units 16 are respectively arranged in the sides of the vehicle 1 in the vehicle transverse direction rearward from the rear wheels of the vehicle 1. The radio waves Sd transmitted from the first exterior communication unit 16a have a relatively higher received signal strength when received in region G1 than when received in other regions. The region G1 extends rearward and rightward from the vehicle 1. The radio waves Sd transmitted from the second exterior communication unit 16b have a relatively higher received signal strength when received in region G2 than when received in other regions. The region G2 extends rearward and leftward from the vehicle 1. Region G1 and region G2 overlap in region G3 at the rear of the vehicle 1. Thus, data Da and data Db are both large in region G3. Accordingly, when data Da and data Db are greater than or equal to a predetermined threshold value, the region G3, or the rearward area, is detected. In the present embodiment, area Ed is defined within region G3.

When the position determination unit 31 determines that the terminal 2 is located in area Ea or Eb, the position determination unit 31 compares data Da and Db with the predetermined threshold value. When data Da and Db are both greater than or equal to the predetermined threshold value, the position determination unit 31 determines that the terminal 2 is located in area Ed. The predetermined threshold value is set through experiments and the like so as to form a desired area Ed.

When ID verification is accomplished and it is determined that the terminal 2 is located in area Ea, area Eb, or area Ed, the body ECU 5 controls actuation of the door lock device 11 based on a detection signal of the touch sensor 13 or the lock button 14. The body ECU 5 can control the vehicle door 10 that is to be actuated in accordance with area Ea, Eb, or Ed where the terminal 2 is located.

When the engine switch 15 is operated under the condition that ID verification has been accomplished and it has been determined that the terminal 2 is located in area Ec, the engine ECU 7 controls the transition state of the engine 6. In this manner, actuation of the vehicle 1 in accordance with the position of the terminal 2 can be executed by determining the area of the vehicle 1 in which the terminal 2 is located with the position determination system 30.

The radio waves Sd are easily blocked by metal material. The exterior communication units 16 are not exposed to the outside of the vehicle 1 to avoid wear caused by the outside environment such as rain and sunlight. If the exterior communication units 16 were to be surrounded by metal materials, the radio waves Sd propagating from the exterior communication units 16 toward the outside of the vehicle 1 would be blocked. This may reduce the received signal strength of the radio waves Sd from the exterior communication units 16 and hinder determination that the terminal 2 is located outside the passenger compartment even when it is.

In the present embodiment, the exterior communication units 16 are arranged inside the rear bumper 41 that is formed from a resin material. The radio waves Sd transmitted from the exterior communication units 16 propagate through the rear bumper 41 toward the outside of the vehicle 1. Further, the radio waves Sd transmitted from the exterior communication units 16 propagate through the resin wheel well covers 43 in the vicinity of the rear wheels toward the outside of the vehicle. This limits decreases in the received signal strength of the radio waves Sd from the exterior communication units 16.

The interior communication unit 17 is arranged inside the vehicle proximate to the floor surface 44a of the passenger compartment 44. With this configuration, the radio waves Sd transmitted from the interior communication unit 17 propagate through the transmissive member 45 out of the vehicle. Also, the radio waves Sd propagating from inside the vehicle near the floor surface 44a toward the outside are diffracted in the vehicle height direction by barriers, such as the metal vehicle doors 10 and the metal body parts 40 of the passenger compartment 44. This diffraction reduces the received signal strength C when the terminal 2 is located outside the passenger compartment of the vehicle. Therefore, the received signal strength C becomes relatively smaller than the received signal strengths A and B when the terminal 2 is located outside the vehicle.

The present embodiment has the following advantages.

(1) The vehicle 1 includes the exterior communication units 16 arranged outside the passenger compartment of the vehicle 1 and the interior communication unit 17 arranged inside the passenger compartment of the vehicle 1. The position determination system 30 includes the data acquisition unit 33 that obtains data Da, Db, and Dc of the received signal strengths A, B, and C measured from the radio waves Sd respectively transmitted from the exterior communication units 16 and the interior communication unit 17 to the terminal 2. Further, the position determination system 30 includes the position determination unit 31 that determines whether the terminal 2 is located outside or inside the passenger compartment of the vehicle 1 from a comparison result of the data obtained through communication performed between the exterior communication units 16 and the terminal 2 and the data obtained through communication performed between the interior communication unit 17 and the terminal 2. The exterior communication units 16 are arranged inside the body parts 40 near the rear wheels of the vehicle 1. With this configuration, radio waves propagate from the exterior communication units 16 through the resin materials located near the rear wheels to the terminal 2. Therefore, when the terminal 2 is located outside the passenger compartment of the vehicle 1, there is not much metal material of the vehicle 1 that blocks the radio waves Sd between the exterior communication unit 16 and the terminal 2 and reduces the received signal strengths A and B. This allows the position of the terminal 2 to be determined correctly.

(2) The body parts 40 include the resin rear bumper 41 of the vehicle 1. The exterior communication units 16 are arranged inside the rear bumper 41. With this configuration, the exterior communication units 16 can establish communication with the terminal 2 through the resin rear bumper 41.

(3) The exterior communication units are arranged at the ends 41a of the body part 40 in the vehicle transverse direction. With this configuration, the exterior communication units 16 are located near the side surfaces of the vehicle 1 in the vehicle transverse direction outside the passenger compartment. This increases the received signal strengths of the radio waves transmitted from the exterior communication units 16 to the terminal 2 when located outside the vehicle 1 in the vehicle transverse direction.

(4) The exterior communication unit 16 includes the first exterior communication unit 16a and the second exterior communication unit 16b that are respectively arranged on the two sides of the vehicle 1 in the vehicle transverse direction. The data acquisition unit 33 acquires data Da obtained through communication performed between the first exterior communication unit 16a and the terminal 2, data Db obtained through communication performed between the second exterior communication unit 16b and the terminal 2, and data Dc obtained through communication performed between the interior communication unit 17 and the terminal 2. The position determination unit 31 compares data Da, data Db, and data Dc to determine whether the terminal 2 is located in area Ea at one side of the vehicle, in the vehicle transverse direction, outside the passenger compartment of the vehicle 1, area Eb at the other side of the vehicle, in the vehicle transverse direction, outside the passenger compartment of the vehicle 1, or area Ec inside the passenger compartment of the vehicle 1. This configuration allows for determination of whether the terminal 2 is located outside or inside the passenger compartment of the vehicle 1, and further, whether the terminal 2 is located in area Ea or area Eb outside the vehicle. This improves convenience for the user.

(5) When determining that the terminal 2 is located outside the passenger compartment of the vehicle 1 and data Da and data Db are greater than or equal to the predetermined threshold value, the position determination unit 31 determines that the terminal 2 is located in the rearward area Ed outside the passenger compartment of the vehicle 1. This configuration allows for determination of whether the terminal 2 is located in the rearward area Ed and improves convenience for the user.

(6) The radio waves Sd transmitted between the exterior communication unit 16 and the terminal 2 differ in frequency from the radio waves Sd transmitted between the interior communication unit 17 and the terminal 2. This configuration decreases the effects of interference from other radio waves on the measurements as compared with when the radio waves Sd are transmitted on the same frequency. Accordingly, the measurement results are less affected by differences in the measurements of the received signal strengths A, B, and C.

(7) Data Da, Db, and Dc include the average values of measurements of the corresponding received signal strengths A, B, and C that are taken between the terminal 2 and each of the exterior communication units 16 and between the terminal 2 and the interior communication unit 17. With this configuration, the measurement results are less affected by differences in the measurements of the received signal strengths A, B, and C.

(8) The vehicle 1 includes barriers blocking the radio waves Sd, such as the vehicle doors 10 and the body parts 40. The interior communication unit 17 is arranged where the barriers reduce the received signal strength C of the radio waves Sd when communication is performed with the terminal 2 that is located outside the passenger compartment of the vehicle 1. With this configuration, the radio waves Sd propagating from inside to outside of the passenger compartment of the vehicle are affected by the barriers in the propagation path and reduced in the received signal strength C when received by the terminal 2 outside the vehicle. Accordingly, the received signal strength C is relatively smaller than the received signal strengths A and B when the terminal 2 is located outside the passenger compartment of the vehicle. This allows the position determination unit 31 to easily determine that the terminal 2 is located outside the vehicle and, in turn, improves the determination accuracy.

(9) The vehicle 1 includes the transmissive members 45 that transmit the radio waves Sd. The transmissive members 45 are arranged at positions separated from the floor surface 44a of the passenger compartment 44 of the vehicle 1 in the vehicle height direction of the vehicle 1. Further, the interior communication unit 17 is arranged proximate to the floor surface 44a. With this configuration, the radio waves Sd transmitted from the interior communication unit 17 travel through the transmissive members 45 out of the vehicle. The radio waves Sd transmitted from the interior communication unit 17 near the floor surface 44a are diffracted in the vehicle height direction by the barriers, such as the metal vehicle doors 10 and the metal body parts 40 of the passenger compartment 44. This diffraction reduces the received signal strength C of the interior communication unit 17 when the terminal 2 is located outside the passenger compartment of the vehicle. Accordingly, the received signal strength C of the interior communication unit 17 is relatively smaller than the received signal strengths A and B of the exterior communication units 16 when the terminal 2 is located outside the vehicle. This allows the position determination unit 31 to easily determine that the terminal 2 is located outside the vehicle and, in turn, improves the determination accuracy.

(10) The position determination system 30 includes the correction unit 34 that corrects at least one of data Da, Db, serving as the first received signal strength data, and data Dc, serving as the second received signal strength data. The position determination unit 31 determines the position of the terminal 2 relative to the vehicle 1 from a comparison result of data Da, Db, and Dc subsequent to correction performed by the correction unit 34. This configuration corrects data Da, Db, and Dc in accordance with the environment in which the position determination system 30 is installed. Thus, the terminal 2 is easily determined as being locate outside the passenger compartment when it is and inside the passenger compartment when it is. This improves the determination accuracy.

The present embodiment may be modified as follows. The present embodiment and the following modifications can be combined as long as the combined modifications remain technically consistent with each other.

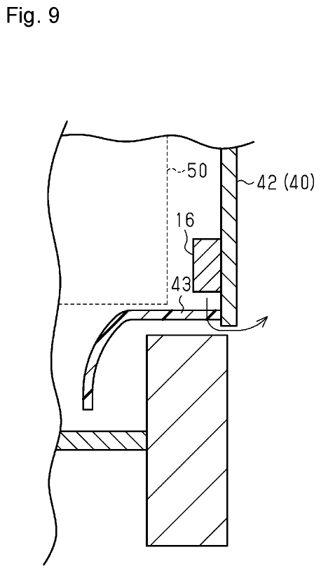

As shown in FIG. 9, the exterior communication unit 16 may be arranged inside the rear fender 42. The rear fender 42 may include a compartment surrounded by the rear fender 42, the wheel well cover 43, and another member 50 such as an inner panel or a body frame located at the inner side of the rear fender 42. Alternatively, the rear fender 42 may also include another compartment connected to the above compartment. In this case, the radio waves Sd propagate from the exterior communication unit 16 through the resin wheel well cover 43 out of the vehicle 1. Thus, the exterior communication unit 16 may be arranged inside the body part 40 near the rear wheel.

The body parts 40 located near the rear wheel of the vehicle 1 are not limited to those described in the present embodiment. The body parts 40 may include, for example, the wheel well cover 43 or a member located adjacent to the wheel well cover 43.

The correction unit 34 may perform multiplication using a preset correction amount F to execute correction.

The correction unit 34 may use different correction amounts when correcting data Da and data Db.

The correction unit 34 does not have to use the preset correction amount F. For example, the correction unit 34 may use calculation results based on the received signal strengths A, B, and C or change the correction amount F in accordance with the area in which the terminal 2 is located.

The correction unit 34 may correct one of or both of the first received signal strength data and the second received signal strength data.

The correction unit 34 may be omitted, and comparison of uncorrected data Da, Db, and Dc may be used for position determination.

Data Da, Db, and Dc are not limited to the average values of the received signal strengths A, B, and C. The median values, the maximum values, or the received signal strengths A, B, and C may be used. That is, any data related to the received signal strengths A, B, and C may be used. In other words, the received signal strength data includes a value related to the received signal strength, for example, the average value, median value, or maximum value of received signal strengths.

The position determination unit 31 may perform only position determination based on a result of comparison between at least the received signal strength data obtained through communication performed between the exterior communication units 16 and the terminal 2 and the received signal strength data obtained through communication performed between the interior communication unit 17 and the terminal 2. For example, when “Da>Dc and Dc>Db” is satisfied, it may be determined that the terminal 2 is located in area Ea. Further, when “Db>Dc and Dc>Da” is satisfied, it may be determined that the terminal 2 is located in area Eb. Thus, any method may be implemented for the area determination.

The position determination unit 31 may determine the area of the vehicle 1 in which the terminal 2 is located or determine whether the terminal 2 is located inside or outside the passenger compartment of the vehicle 1. Further, it may be determined whether the terminal 2 is located at the front side or the rear side of the vehicle 1.

The transmission interval of radio waves Sd is not limited and may be changed in accordance with the specification of the position determination system 30.

The radio waves Sd do not have to include the communication unit ID of the communication unit from which the radio waves Sd are transmitted. For example, the position determination unit 31 may control when to transmit the radio waves Sd and determine from which communication unit the measurement result was obtained based on when the measurement result of received signal strength was received. Alternatively, the measurement result may be received by the antenna that transmitted the radio waves Sd so as to determine from which communication unit the measurement result was obtained.

The exterior communication unit 16 and the interior communication unit 17 may each transmit a group of the radio waves Sd on different frequencies at the same time.

The terminal 2 may transmit radio waves Sd.

The measurement unit 32 may calculate the average value from a group of the radio waves Sd and notify the vehicle 1 of the average value. That is, the received signal strength data may be calculated by any one of the vehicle 1 and the terminal 2.

The measurement unit 32 may be arranged in the vehicle 1. This may be applied to the configuration in which the terminal 2 transmits radio waves Sd.

The frequencies of the radio waves Sd do not have to be the channels determined through frequency hopping in BLE communication.

The radio waves Sd do not have to be transmitted on different frequencies and may be transmitted on the same frequency.

The radio waves Sd do not have to be transmitted multiple times from each of the exterior communication units 16 and the interior communication unit 17 and may be transmitted only once.

The radio waves Sd may be a position detection signal transmitted for position detection, an advertisement message, or any other types of signals used in the authentication system 3. That is, the radio waves Sd are not limited to the description of the present embodiment.

The relationship that serves as a reference of the position determination is not limited to that used in the present embodiment and may be changed based on, for example, the results obtained through experiments that are conducted with the position determination system 30 installed in the vehicle 1.

The predetermined threshold value used for determining area Ed is not particularly limited and may be set through experiments and the like so as to form a desired area Ed. Further, the threshold value may differ between data Da and data Db.

The interior communication unit 17 may be arranged in the center console, under the driver seat or the passenger seat, or any other positions inside the passenger compartment of the vehicle.

The proximity of the floor surface 44a where the interior communication unit 17 is arranged may include, for example, a position between the end line 45a of the lower end of the transmissive member 45 and the floor surface 44a. Further, the proximity of the floor surface 44a may include a position below the floor surface 44a that is connected with the passenger compartment of the vehicle, for example, inside a seat rail of the driver seat or the passenger seat.

The transmissive member 45 does not have to be a glass member and may be formed from, for example, a resin material.

The interior communication unit 17 does not have to be located proximate to the floor surface 44a and may be arranged in the roof or the instrument panel inside the passenger compartment of the vehicle. When the interior communication unit 17 is disposed in the roof, a barrier may be arranged so that the radio waves Sd are diffracted in the propagation path extending from the interior communication unit 17 to the terminal 2 outside the vehicle.

The barrier is not limited to the vehicle doors 10 or the body parts 40 and may be other parts of the vehicle 1, such as a seat member, a roof member, or the center console.

There is no limitation to the number of the interior communication units 17 and the number may be one, two, three or more.

There is no limitation to the number of the exterior communication units 16 and the number may be one, two, three or more.

The exterior communication units 16 do not have to be arranged symmetrically in the vehicle transverse direction. The arrangement may be changed in accordance with the specification.

The exterior communication units 16 do not have to be arranged on the ends 41a of the rear bumper 41 in the vehicle transverse direction and may be arranged toward the side of the rear bumper 41 facing the rear of the vehicle.

The authentication system 3 and the position determination system 30 may use communication protocol and bandwidth that differ from that of the above-described examples. For example, Wi-Fi® or ZigBee® may be used. Further, the bandwidth may differ between the systems.

In the series of authentication processes, ID verification and position detection of the terminal 2 may be executed in any order. For example, ID verification may be executed after position detection. Alternatively, the period in which ID verification is executed may overlap the period in which position detection is executed.

The position determination system 30 does not have to be incorporated in the authentication system 3 and may be independently installed in the vehicle 1.

The terminal 2 does not have to be a smartphone and may be an electronic key linked to the vehicle 1. Further, the terminal 2 may be other types of smart devices such as a tablet computer or a laptop computer.

The verification ECU 4 can be circuitry including one or more processors that run on a computer program (software) to execute various processes, one or more exclusive hardware circuits such as an application specific integrated circuit (ASIC) that execute at least part of various processes, or a combination of the above. A processor includes a central processing unit (CPU) and a memory, such as a random-access memory (RAM) or a read-only memory (ROM). The memory stores program codes or commands that are configured to have the CPU execute processes. The memory, which is a computer readable medium, may be any available medium that is accessible by a versatile or dedicated computer.

1. A position determination system, comprising:
a data acquisition unit that obtains received signal strength data of a received signal strength measured from radio waves used in communication performed between a terminal and an exterior communication unit, arranged outside a passenger compartment of a vehicle, and received signal strength data of a received signal strength measured from radio waves used in communication performed between the terminal and an interior communication unit, arranged inside the passenger compartment of the vehicle; and
a position determination unit that determines whether the terminal is located outside or inside the passenger compartment of the vehicle from a comparison result of the received signal strength data obtained through communication performed between the terminal and the exterior communication unit and the received signal strength data obtained through communication performed between the terminal and the interior communication unit,
wherein the exterior communication unit is arranged inside a body part near a rear wheel of the vehicle.

2. The position determination system according to claim 1, wherein
the body part is a resin rear bumper of the vehicle, and
the exterior communication unit is arranged at inside the rear bumper.

3. The position determination system according to claim 1, wherein
the exterior communication unit is arranged at an end of the body part in a vehicle transverse direction.

4. The position determination system according to claim 1, wherein
the exterior communication unit is one of two exterior communication units,
the two exterior communication units are respectively arranged on two sides of the vehicle in a vehicle transverse direction, and
the position determination unit compares the received signal strength data obtained through communication performed between the terminal and one of the two exterior communication units that is arranged at a first side in the vehicle transverse direction, the received signal strength data obtained through communication performed between the terminal and the other one of the two exterior communication units that is arranged at a second side in the vehicle transverse direction, and the received signal strength data obtained through communication performed between the terminal and the interior communication unit to determine whether the terminal is located in an area at the first side in the vehicle transverse direction outside the passenger compartment of the vehicle, an area at the second side in the vehicle transverse direction outside the passenger compartment of the vehicle, or an internal area inside the passenger compartment of the vehicle.

5. The position determination system according to claim 1, wherein
the exterior communication unit is one of two exterior communication units,
the two exterior communication units are respectively arranged on two sides of the vehicle in a vehicle transverse direction, and
when determining that the terminal is located outside the passenger compartment of the vehicle and the received signal strength data of each of the two exterior communication units at the two sides in the vehicle transverse direction is greater than or equal to a predetermined threshold value, the position determination unit determines that the terminal is located in a rearward area outside the passenger compartment of the vehicle.

6. The position determination system according to claim 1, wherein the radio waves transmitted between the exterior communication unit and the terminal differ in frequency from the radio waves transmitted between the interior communication unit and the terminal.

7. The position determination system according to claim 1, wherein
the received signal strength data obtained through communication performed between the terminal and the exterior communication unit includes an average value of received signal strengths measured between the terminal and the exterior communication unit, and
the received signal strength data obtained through communication performed between the terminal and the interior communication unit includes an average value of received signal strengths measured between the terminal and the interior communication unit.

8. The position determination system according to claim 1, wherein
the vehicle includes a barrier that blocks the radio waves, and
the interior communication unit is arranged where the barrier reduces the received signal strength of the radio waves when communication is performed with the terminal that is located outside the passenger compartment of the vehicle.

9. The position determination system according to claim 1, wherein
the vehicle includes a transmissive member that transmits the radio waves, the transmissive member being arranged at a position separated from a floor surface of the vehicle in a vehicle height direction of the vehicle, and
the interior communication unit is arranged proximate to the floor surface.

10. The position determination system according to claim 1, further comprising:
a correction unit that corrects at least one of a first received signal strength data, serving as the received signal strength data obtained through communication performed between the terminal and the exterior communication unit, and a second received signal strength data, serving as the received signal strength data obtained through communication performed between the terminal and the interior communication unit;
wherein the position determination unit determines a position of the terminal from a comparison result of the first received signal strength data and the second received signal strength data subsequent to correction performed by the correction unit.
